(19) United States
(12) Patent Application Publication
(10) Pub. No.: US 2012/0262610 A1
(43) Pub. Date: Oct. 18, 2012

(54) Pixel Information Reproduction Using Neural Networks

(75) Inventors: Tero Rissa, Siivikkala (FI); Matti Viikinkoski, Tampere (FI)

(73) Assignee: NOKIA CORPORATION, Espoo (FI)

(21) Appl. No.: 13/517,984

(22) PCT Filed: Dec. 23, 2009
(86) PCT No.: PCT/FI2009/051031

§ 371 Date: Jun. 21, 2012

(51) Int. Cl. H04N 9/04

(52) U.S. Cl. 348/273; 348/E09.003

(57) ABSTRACT

The invention relates to forming an image using binary pixels. Binary pixels are pixels that have only two states, a white state when the pixel is exposed and a black state when the pixel is not exposed. The binary pixels have color filters on top of them, and the setup of color filters may be initially unknown. A neural network may be used to learn the color filter setup to produce correct output images. Subsequently, the trained neural network may be used with the binary pixel array to produce images from the input images that the binary pixel array records.

### BACKGROUND

A binary image sensor may comprise e.g. more than 10⁹ individual light detectors arranged as a two-dimensional array. Each individual light detector has two possible states: an unexposed “black” state and an exposed “white” state. Thus, an individual detector does not reproduce different shades of grey. The local brightness of an image may be determined e.g. by the local spatial density of white pixels. The size of the individual light detectors of a binary image sensor may be smaller than the minimum size of a focal spot which can be provided by the imaging optics of a digital camera.

However, storing or transferring binary digital images as such may be difficult or impossible due to the large data size. The resulting image data may even be so large that storing and processing of the binary digital images becomes impractical in a digital camera, or even in a desktop computer.

There is, therefore, a need for a solution that improves the applicability of binary digital image sensors to practical solutions.

### SUMMARY

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

Binary pixels are pixels that have only two states, a white state when the pixel is exposed and a black state when the pixel is not exposed. The binary pixels have color filters on top of them, and the setup of color filters may be initially unknown. A neural network may be used to learn the color filter setup to produce correct output images. Subsequently, the trained neural network may be used with the binary pixel array to produce images from the input images that the binary pixel array records.

According to a first aspect there is provided a method for forming pixel values, comprising receiving binary pixel values in an image processing system, the binary pixel values having been formed with binary pixels with color filters, and applying a neural network to said binary pixel values to produce output pixel values.

According to an embodiment, the method further comprises exposing said binary pixels to light through color filters superimposed on said binary pixels, said light having passed through an optical arrangement, and forming said binary pixel values from the output of said binary pixels. According to an embodiment, the method further comprises setting parameters or weights in said neural network corresponding to said binary pixels, and forming at least one output pixel value from the output of said neural network. According to an embodiment, the method further comprises calculating a value of a neuron in said neural network by applying weights to input signals to said neuron and by calculating the output of said neuron using an activation function, and calculating values of neurons in layers in said neural network, wherein the layers comprise at least one of the group of an input layer, a hidden layer and an output layer.

According to a second aspect, there is provided an apparatus comprising at least one processor, memory including computer program code, the memory and the computer program code configured to, with the at least one processor, cause the apparatus to receive binary pixel values in an image processing system, the binary pixel values having been formed with binary pixels with color filters, and apply a neural network to said binary pixel values to produce output pixel values.

According to an embodiment, the apparatus further comprises computer program code configured to, with the processor, cause the apparatus to expose said binary pixels to light through color filters superimposed on said binary pixels, said light having passed through an optical arrangement, and form said binary pixel values from the output of said binary pixels. According to an embodiment, the apparatus further comprises computer program code configured to, with the processor, cause the apparatus to set parameters or weights in said neural network corresponding to said binary pixels, and form at least one output pixel value from the output of said neural network. According to an embodiment, the apparatus further comprises computer program code configured to, with the processor, cause the apparatus to calculate a value of a neuron in said neural network by applying weights to input signals to said neuron and by calculating the output of said neuron using an activation function, and calculate values of neurons in layers in said neural network, wherein the layers comprise at least one of the group of an input layer, a hidden layer and an output layer. According to an embodiment, the apparatus further comprises a color signal unit comprising at least one said neural network, and a memory for storing parameters and/or weights of at least one said neural network. According to an embodiment, the apparatus further comprises an optical arrangement for forming an image, an array of binary pixels for detecting said image, and groups of said binary pixels. According to an embodiment, the apparatus further comprises at least one color filter superimposed on an array of binary pixels, said color filter being superimposed on said array of binary pixels in a manner that is at least one of the group of non-aligned, irregular, random, and unknown superimposition.

According to a third aspect, there is provided a method for adapting an image processing system, comprising receiving binary pixel values in an image processing system, the binary pixel values having been formed with binary pixels with color filters, applying a neural network to said binary pixel values to produce output pixel values, comparing information on said received binary pixel values to information on said output pixel values, and based on said comparing, adapting parameters of said neural network.

According to an embodiment, the method further comprises exposing said binary pixels to light through color filters superimposed on said binary pixels, said light having passed through an optical arrangement, and forming said binary pixel values from the output of said binary pixels. According to an embodiment, the method further comprises calculating a value of a neuron in said neural network by applying weights to input signals to said neuron and by calculating the output of said neuron using an activation function, and calculating values of neurons in layers in said neural network, wherein the layers comprise at least one of the group of an input layer, a hidden layer and an output layer.

According to a fourth aspect, there is provided an apparatus comprising at least one processor, memory including computer program code, the memory and the computer program code configured to, with the at least one processor, cause the apparatus to receive binary pixel values in an image processing system, the binary pixel values having been formed with binary pixels with color filters, apply a neural network to said binary pixel values to produce output pixel values, compare information on said received binary pixel values to information on said output pixel values, and based on said comparing, adapt parameters of said neural network.

According to an embodiment, the apparatus further comprises computer program code configured to, with the processor, cause the apparatus to expose said binary pixels to light through color filters superimposed on said binary pixels, said light having passed through an optical arrangement, and form said binary pixel values from the output of said binary pixels. According to an embodiment, the apparatus further comprises computer program code configured to, with the processor, cause the apparatus to calculate a value of a neuron in said neural network by applying weights to input signals to said neuron and by calculating the output of said neuron using an activation function, and calculate values of neurons in layers in said neural network, wherein the layers comprise at least one of the group of an input layer, a hidden layer and an output layer.

According to a fifth aspect, there is provided a computer program product stored on a computer readable medium and executable in a data processing device, wherein the computer program product comprises a computer program code section for receiving binary pixel values, the binary pixel values having been formed with binary pixels with color filters, a computer program code section for applying a neural network to said binary pixel values to produce output pixel values, and a computer program code section for using said output pixel values to form an output image. According to an embodiment, the computer program product further comprises a computer program code section for receiving parameters or weights for said neural network, a computer program code section for setting said parameters or weights in a neural network, and a computer program code section for forming output pixel values from the output of said neural network.

According to a sixth aspect, there is provided an apparatus comprising processing means, memory means, means for receiving binary pixel values in an image processing system, the binary pixel values having been formed with binary pixels with color filters, and means for applying a neural network to said binary pixel values to produce output pixel values.

### DESCRIPTION OF THE DRAWINGS

In the following, various embodiments of the invention will be described in more detail with reference to the appended drawings, in which

FIG. 1a shows a binary image;

FIG. 1b shows a density of white pixels as a function of exposure;

FIG. 2a shows a grey-scale image of a girl;

FIG. 2b shows a binary image of a girl;

FIG. 3a shows probability of white state for a single pixel;

FIG. 3b shows dependence of white state probability on wavelength;

FIG. 4 shows a Bayer matrix type color filter on top of a binary pixel array for capturing color information;

FIG. 5 shows a random color filter on top of a binary pixel array for forming output pixels;

FIG. 6 shows a block diagram of an imaging device;

FIG. 7 shows a color signal unit for forming output pixels from binary pixels;

FIG. 8 shows an arrangement for determining a color filter layout overlaying a binary pixel array;

FIG. 9 shows an arrangement for determining color of incoming light with a color filter overlaying a binary pixel array;

FIG. 10 shows a neural network for forming an output pixel value from binary input pixel values;

FIG. 11 shows a neural network arrangement for forming output pixel values from binary input pixel values;

FIG. 12 shows a neural network system with a memory for forming output pixel values from binary input pixel values;

FIG. 13 shows a neural network system with a memory for forming output pixel values from binary input pixel values;

FIG. 14a shows a teaching arrangement of a neural network for forming output pixel values from binary input pixel values;

FIG. 14b shows an arrangement for applying a neural network for forming output pixel values from binary input pixel values;

FIG. 15a shows a method for producing an output image from binary input pixels using a neural network;

FIG. 15b shows another method for producing an output image from binary input pixels using a neural network; and

FIG. 16 shows a method for teaching a neural network for producing output image from binary input pixels.

### DESCRIPTION OF EXAMPLE EMBODIMENTS

In the following, several embodiments of the invention will be described in the context of a binary pixel array. It is to be noted, however, that the invention is not limited to binary pixel arrays. In fact, the different example embodiments have applications widely in any environment where mapping of input pixel values to output pixel values through a partly uncertain process is exploited.

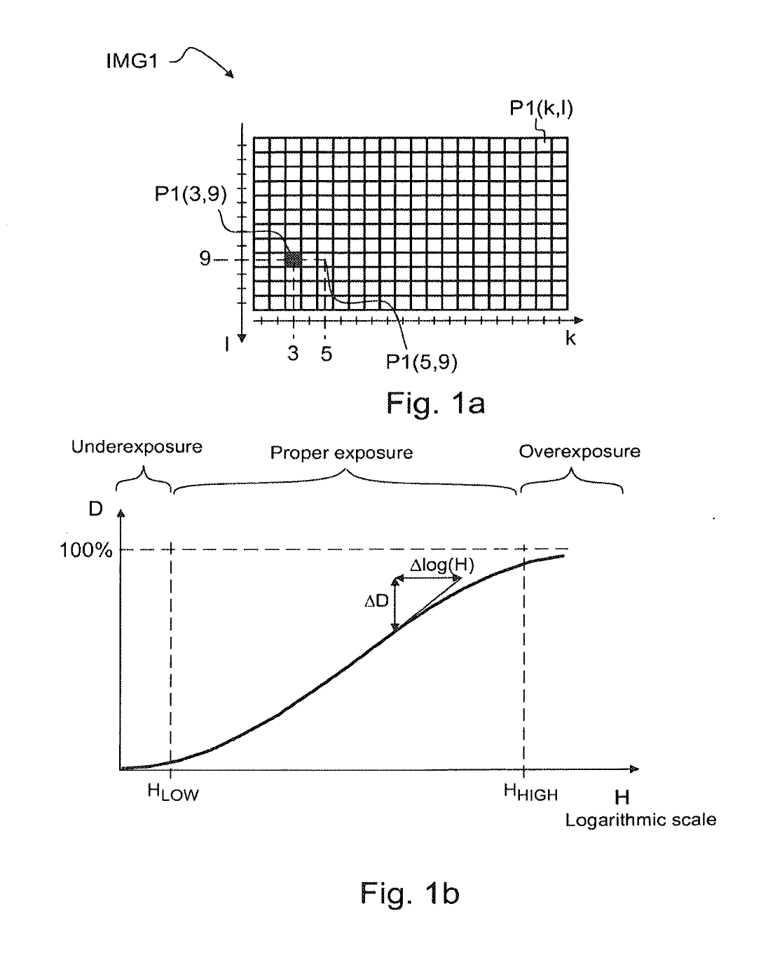

Referring to FIG. 1a, the image sensor applied in the example embodiments may be a binary image sensor arranged to provide a binary image IMG1. The image sensor may comprise a two-dimensional array of light detectors such that the output of each light detector has only two logical states. Said logical states are herein called as the “black” state and the “white” state. The image sensor may be initialized such that all detectors may be initially at the black state. An individual detector may be switched into the white state by exposing it to light. Thus, a binary image IMG1 provided by the image sensor may consist of pixels P1, which are either in the black state or in the white state, respectively. The expressions “white pixel” and “the pixel is white” refer to a pixel which is in the white state. The expression “black pixel” refers to a pixel which is in the black state, respectively. These expressions are not indicative of the color of the pixel, they merely describe whether the pixel has been activated (white state or “lit”) due to light or whether it remains inactive (black state or “unlit”).

The pixels P1 may be arranged in rows and columns, i.e. the position of each pixel P1 of an input image IMG1 may be defined by an index k of the respective column and the index I of the respective row. For example, the pixel P1(3,9) shown in FIG. 1a is black and the pixel P1(5,9) is white.

A binary light detector may be implemented e.g. by providing a conventional (proportional) light detector which has a very high conversion gain (low capacitance). Other possible approaches include using avalanche or impact ionization to provide in-pixel gain, or the use of quantum dots.

FIG. 1b shows an estimate for the density D of white pixels P1 as a function of optical exposure H. The exposure H is presented in a logarithmic scale. The density D means the ratio of the number of white pixels P1 within a portion of the image IMG1 to the total number of pixels P1 within said portion. A density value 100% means that all pixels within the portion are in the white state. A density value 0% means that all pixels within the portion are in the black state. The optical exposure H is proportional to the optical intensity and the exposure time. The density D is 0% at zero exposure H. The density increases with increasing exposure until the density begins to saturate near the upper limit 100%.

The conversion of a predetermined pixel P1 from black to white is a stochastic phenomenon. The actual density of white pixels P1 within the portion of the image IMG1 follows the curve of FIG. 1b when said portion contains a high number of pixels P1.

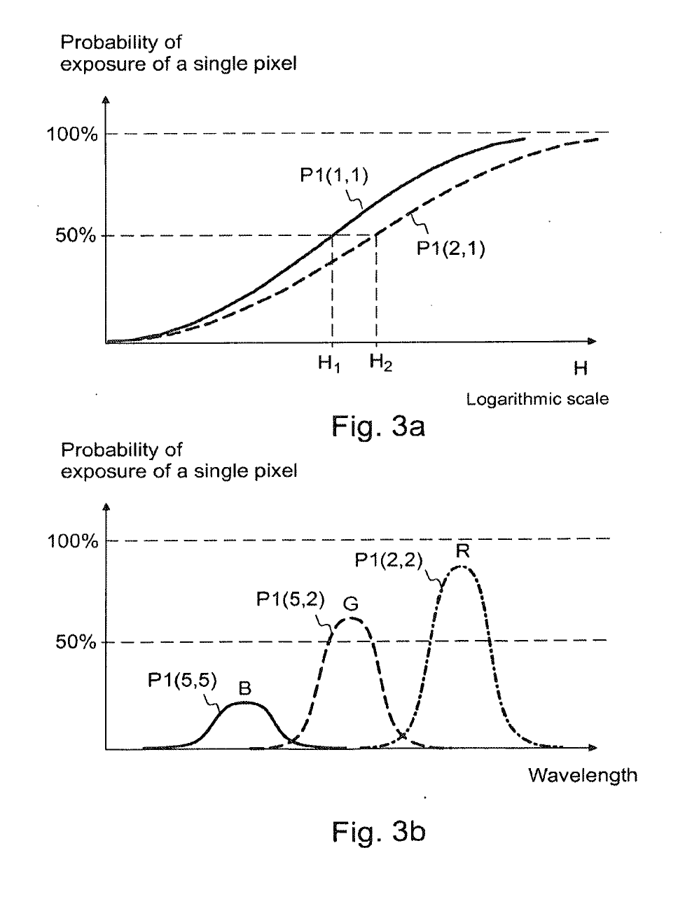

In case of individual pixels, the curve of FIG. 1b may also be interpreted to represent the probability for a situation where the state of a predetermined pixel P1 is converted from the black state to the white state after a predetermined optical exposure H (see also FIGS. 3a and 3b).

An input image IMG1 is properly exposed when the slope AD/Alog(H) of the exposure curve is sufficiently high (greater than or equal to a predetermined value). Typically, this condition is attained when the exposure H is greater than or equal to a first predetermined limit HLOW and smaller than or equal to a second predetermined limit HHIGH. Consequently the input image may be underexposed when the exposure H is smaller than the first predetermined limit HLOW, and the input image may be overexposed when the exposure H is greater than the second predetermined limit HHIGH.

The signal-to-noise ratio of the input image IMG1 or the signal-to-noise ratio of a smaller portion of the input image IMG1 may be unacceptably low when the exposure H is smaller than the first limit HLOW or greater than the second limit HHIGH. In those cases it may be acceptable to reduce the effective spatial resolution in order to increase the signal-to-noise ratio.

The exposure state of a portion of a binary image depends on the density of white and/or black pixels within said portion. Thus, the exposure state of a portion of the input image IMG1 may be estimated e.g. based on the density of white pixels P1 within said portion. The density of white pixels in a portion of an image depends on the density of black pixels within said portion.

The exposure state of a portion of the input image IMG1 may also be determined e.g. by using a further input image IMG1 previously captured by the same image sensor. The exposure state of a portion of the input image IMG1 may also be estimated e.g. by using a further image captured by a further image sensor.

The further image sensor which can be used for determining the exposure state may also be an analog sensor. The analog image sensor comprises individual light detectors, which are arranged to provide different grey levels, in addition to the black and white color. Different portions of an image captured by an analog image sensor may also be determined to be underexposed, properly exposed, or overexposed. For example, when the brightness value of substantially all pixels in a portion of an image captured by an analog image sensor are greater than 90%, the image portion may be classified to be overexposed. For example, when the the brightness value of substantially all pixels in a portion of an image captured by an analog image sensor are smaller than 10%, the image portion may be classified to be underexposed. When a considerable fraction of pixels have brightness values in the range of 10% to 90%, then the image portion may be properly exposed, respectively.

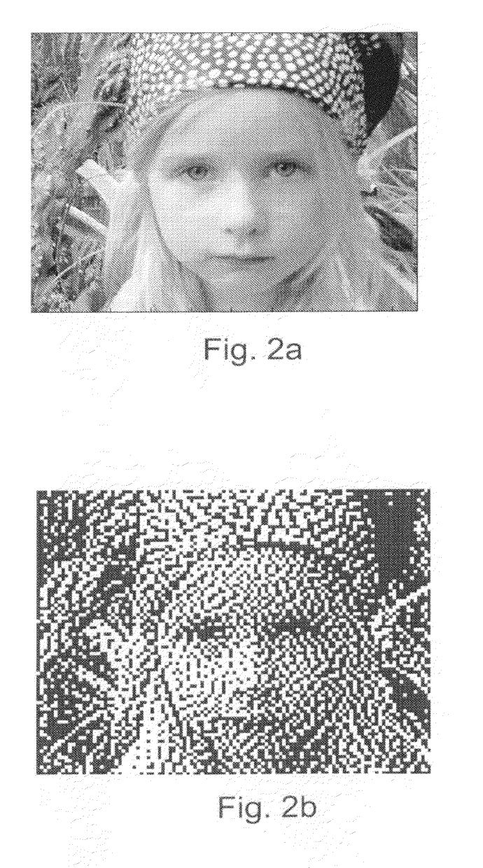

FIG. 2a shows, by way of example, an image of a girl in grey scale. FIG. 2b shows a binary image corresponding to the image of FIG. 2a. The image of FIG. 2b has a large pixel size in order to emphasize the black and white pixel structure. In reality, binary pixels that make up the image of FIG. 2b are often smaller than the output pixels that make up the image of FIG. 2a. Several binary pixels of FIG. 2b may correspond to one analog pixel of FIG. 2a. The density of binary pixels in the white state in FIG. 2b may have a correspondence to the grey scale brightness of an analog pixel in FIG. 2a.

FIG. 3a shows probability of exposure or state changing for a single binary pixel, i.e. the probability that the state of a single predetermined pixel is changed from the black state to the white state. In FIG. 1b, the density of white pixels compared to black pixels as a function of intensity H was shown. Correspondingly, with reference to FIG. 3a, a pixel has a probability of being in a white state, and this probability is a function of intensity. For example, the pixel P1(1,1) has a 50% probability of being in the white state when the optical exposure is H₁ and the pixel P1(2,1) has a 50% probability of being in the white state when the optical exposure is H₂. As mentioned above, the optical exposure H is proportional to the optical intensity and the exposure time. Different pixels may have different probability curves, i.e. they may have a different probability of being in the white state with the same intensity H of incoming light.

FIG. 3b shows state changing probability for a single binary pixel as a function of wavelength of light impinging on a combination of a color filter and the binary pixel. In FIG. 3b, it is assumed that various binary pixels may have a color filter imposed on top of them so that a certain color band of incoming light is able to pass trough. In such an arrangement, different binary pixels may have a different probability of being in the white state when they are exposed to light that has the same intensity but different wavelength (color).

For example, in FIG. 3b the pixel P1(5,5) is responsive to light that has a wavelength corresponding essentially to the blue color. When the wavelength of the incoming light deviates from the blue color, the pixel P1(5,5) has a lower probability of being in the exposed (white) state. Likewise, the pixel P1(5,2) is responsive to light that has a wavelength corresponding essentially to the green color, and the pixel P1(2,2) is responsive to light that has a wavelength corresponding essentially to the red color.

The color filters on top of the binary pixels may seek to act as band-pass filters whereby the underlying pixels are responsive only to light in a certain color band, e.g. red, green or blue or any other color or wavelength. However, the color filters may be imperfect either intentionally or by chance, and the band-pass filter may “leak” so that other colors are let through, as well.

The probability of a pixel being exposed as a function of wavelength may not be a regularly-shaped function like the bell-shaped functions in FIG. 3b for a blue pixel (solid line), green pixel (dashed line) and red pixel (dash-dot line). Indeed, the probability function may be irregular, it may have several maxima, and it may have a fat tail (i.e. a long tail which has a non-negligible magnitude) so that the probability of e.g. a red pixel being exposed with blue light is not essentially zero, but may be e.g. 3%, 10% or 30% or even more.

The state-changing probability functions of pixels of different color may be essentially non-overlapping, as in the case of FIG. 3b, so that light of single color has a probability of exposing pixels of essentially the same color, but not others. The state-changing probability functions may also be overlapping so that light between red and green wavelengths has a significant probability of exposing both red pixel P1(2,2) and green pixel P1(5,2). The state-changing probability functions may also vary from pixel to pixel.

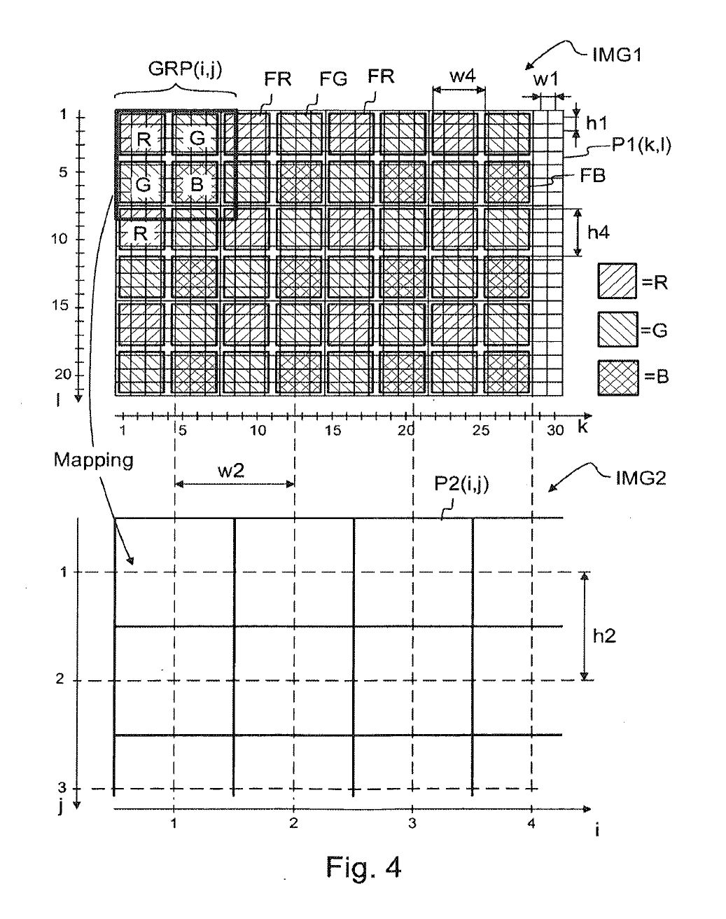

FIG. 4 shows a Bayer matrix type color filter on top of a binary pixel array for forming output pixels. The pixel coordinates of the binary pixels P1(k,l) in FIG. 4 correspond to FIG. 3b and create an input image IMG1. A Bayer matrix is an arrangement with color filters, which are placed on top of light sensors in a regular layout, where every second filter is green, and every second filter is red or blue in an alternating manner. Therefore, as shown in FIG. 4, essentially 50% of the filters are green (shown with downward diagonal texture), essentially 25% are red (shown with upward diagonal texture) and essentially 25% are blue (shown with cross pattern texture). In an setup where a Bayer matrix is placed on top of a binary pixel array, individual color filters FR, FG and FB may overlap a single binary pixel, or a plurality of binary pixels, for example 4 binary pixels, 9.5 binary pixels, 20.7 binary pixels, 100 binary pixels, 1000 binary pixels or even more. If the distance between the centers of the binary input pixels is w1 in width and h1 in height, the distance between centers of individual Bayer matrix filters may be w4 in width and h4 in height, whereby w4>w1 and h4>h1. Thus the filters may overlap several binary pixels. The individual filters may be tightly spaced, they may have a gap in between (leaving an area in between that lets through all colors) or they may overlap each other. The filters may be square-shaped, rectangular, hexagonal or any other shape.

The binary pixels of image IMG1 may form groups GRP(i,j) corresponding to pixels P2(i,j) of the output image IMG2. In this manner, a mapping between the binary input image IMG1 and the output image IMG2 may be formed. The groups GRP(i,j) may comprise binary pixels that have color filters of different colors. The groups may be of the same size, or they may be of different sizes. The groups may be shaped regularly or they may have an irregular shape. The groups may overlap each other, they may be adjacent to each other or they may have gaps in between groups. In FIG. 4, as an example, the group GRP(1,1) corresponding to pixel P2(1,1) of image IMG2 overlaps 64 (8×8) binary pixels of image IMG1, that is, group GRP(1,1) comprises the pixels P1(1,1)-P1(8,8). The boundaries of the groups GRP(l,j) may coincide with boundaries of the color filters FR, FG, FB, but this is not necessary. The group boundaries may also be displaced and/or misaligned with respect to the boundaries of the Bayer matrix filters. In this manner, the groups GRP(i,j) of image IMG1 may be used to form pixels P2(i,j) in image IMG2. The distance between the centers of the pixels P2(i,j) may be w2 in width and h2 in height. The output pixels P2 may have a size of w2 and h2, respectively, or they may be smaller or larger.

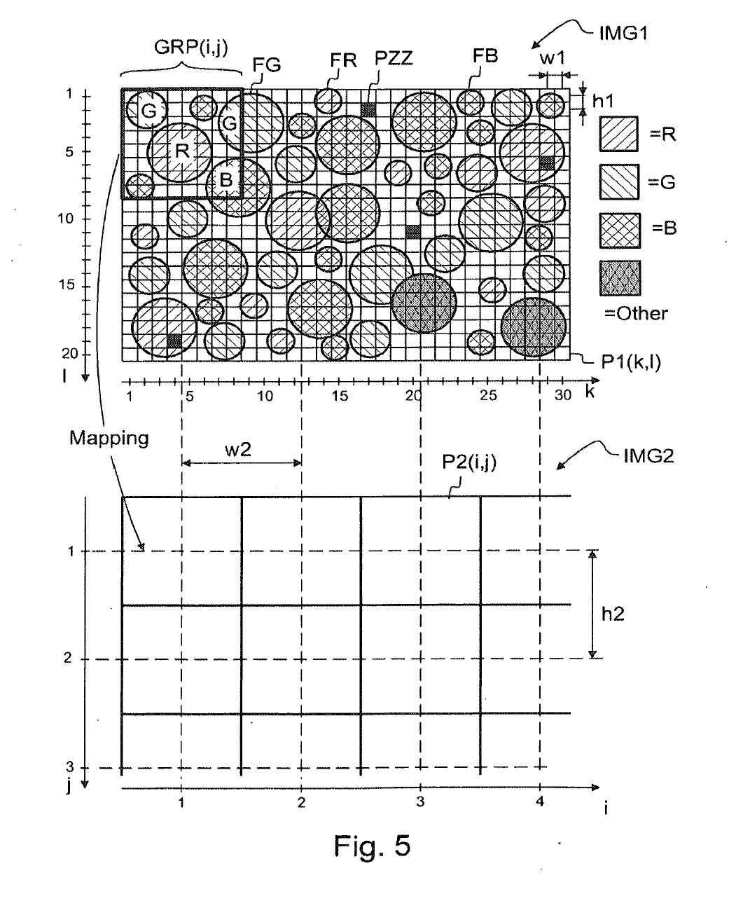

FIG. 5 shows a random color filter on top of a binary pixel array for forming output pixels. As with FIG. 4, the image IMG1 comprises binary pixels P1(k,l) that may be grouped to groups GRP(i,j), the groups corresponding to pixels P2(i,j) in image IMG2, and the setup of the images IMG1 and IMG2 are the same as in FIG. 4. However, in contrast to FIG. 4, the color filters FG, FR and FB of FIG. 5 are not regularly shaped or arranged in a regular arrangement. The color filters may have different sizes, and may be placed on top of the binary pixels in a random manner. The color filters may be spaced apart from each other, they may be adjacent to each other or they may overlap each other. The color filters may leave space in between the color filters that lets through all colors or wavelengths of light, or alternatively, does not essentially let through light at all. Some of the pixels P1(k,l) may be non-functioning pixels PZZ that are permanently jammed to the white (exposed) state, or the black (unexposed) state, or that otherwise give out an erroneous signal that is not well dependent on the incoming intensity of light. The pixels P1(k,l) may have different probability functions for being in the white state as a function of intensity of incoming light. The pixels P1(k,l) may have different probability functions for being in the white state as a function of wavelength of incoming light. These properties may be due to imperfections of the pixels themselves or imperfections of the overlaying color filters. For example, the color filters may have a color Other different from red, green and blue.

With an arrangement like shown in FIG. 5, a group GRP(i,j) may comprise a varying number of binary pixels that have a green G filter, a red R filter or a blue B filter. Furthermore, the different red, green and blue binary pixels may be placed differently in different groups GRP(i,j). The average number of red, green and blue pixels and pixels without a filter may be essentially the same across the groups GRP(i,j), or the average number (density) of red, green and blue pixels and pixels without a filter may vary across groups GRP(i,j) according to a known or unknown distribution.

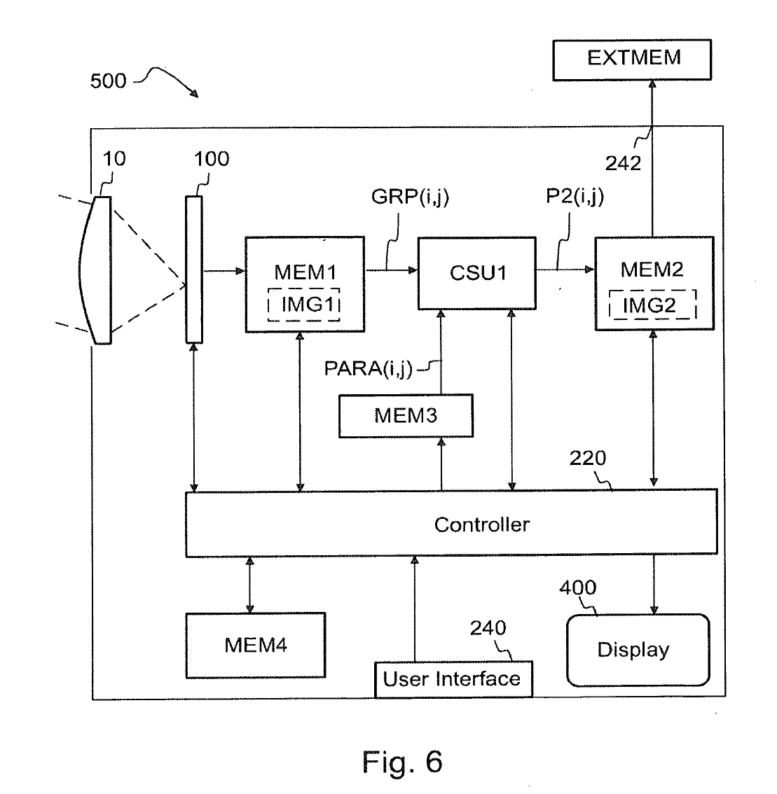

FIG. 6 shows a block diagram of an imaging device. Referring to FIG. 6, an imaging device 500 may comprise imaging optics 10 and an image sensor 100 for capturing a binary digital input image IMG1 of an object, and a signal processing unit (i.e. a Color Signal Unit) CSU1 arranged to provide an output image IMG2 based on an input image IMG1. The imaging optics 10 may be e.g. a focusing lens. The input image IMG1 may depict an object, e.g. a landscape, a human face, or an animal. The output image IMG2 may depict the same object but at a lower spatial resolution or pixel density.

The image sensor 100 may be binary image sensor comprising a two-dimensional array of light detectors. The detectors may be arranged e.g. in more than 10000 columns and in more than 10000 rows. The image sensor 100 may comprise e.g. more than 10⁹ individual light detectors. An input image IMG1 captured by the image sensor 100 may comprise pixels arranged e.g. in 41472 columns and 31104 rows. (image data size 1.3.10⁹ bits, i.e. 1.3 gigabits or 160 megabytes). The corresponding output image IMG2 may have a lower resolution. For example, the corresponding output image IMG2 may comprise pixels arranged e.g. in 2592 columns and 1944 rows (image data size of approximately 5.10⁶ pixels, 8 bits per pixel for each color R,G,B, total data size 1.2.10⁸ bits, i.e. approximately 120 megabits or 15 megabytes). Thus, the image size may be reduced e.g. by a factor of 10 (=1.3.10⁹/1.2.10⁸).

The data size of a binary input image IMG1 may be e.g. greater than or equal to 4 times the data size of a corresponding output image IMG2, wherein the data sizes may be indicated e.g. in the total number of bits needed to describe the image information. If higher data reduction is needed, the data size of the input image IMG1 may be greater than 10, greater than 20, greater than 50 times or even greater than 100 or 1000 times the data size of a corresponding output image IMG2.

The imaging device 500 may comprise an input memory MEM1, an output memory MEM2 to store output images IMG2, a memory MEM3 for storing data related to image processing such as neural network coefficients or weights or other data, an operational memory MEM4 for example to store computer program code for the data processing algorithms and other programs and data, a display 400, a controller 220 to control the operation of the imaging device 500, and an user interface 240 to receive commands from a user.

The input memory MEM1 may at least temporarily store at least a few rows or columns of the pixels P1 of the input image IMG1. Thus, the input memory may be arranged to store at least a part of the input image IMG1, or it may be arranged to store the whole input image IMG1. The input memory MEM1 may be arranged to reside in the same module as the image sensor 100, for example so that each pixel of the image sensor may have one, two or more memory locations operatively connected to the image sensor pixels for storing the data recorded by the image sensor.

The signal processor CSU1 may be arranged to process the pixel values IMG1 captured by the image sensor 100. The processing may happen e.g. using a neural network or other means, and coefficients or weights from memory MEM3 may be used in processing. The signal processor CSU1 may store its output data, e.g. an output image IMG2 to MEM2 or to MEM3 (not shown in picture). The signal processor CSU1 may function independently or it may be controlled by the controller 220, e.g. a general purpose processor. Output image data may be transmitted from the signal processing unit 200 and/or from the output memory MEM2 to an external memory EXTMEM via a data bus 242. The information may be sent e.g. via internet and/or via a mobile telephone network.

The memories MEM1, MEM2, MEM3, and/or MEM4 may be physically located in the same memory unit. For example, the memories MEM1, MEM1, MEM2, MEM3, and/or MEM4 may be allocated memory areas in the same component. The memories MEM1, MEM2, MEM3, MEM4, and/or MEM5 may also be physically located in connection with the respective processing unit, e.g. so that memory MEM1 is located in connection with the image sensor 100, memory MEM3 is located in connection with the signal processor CSU1, and memories MEM3 and MEM4 are located in connection with the controller 220.

The imaging device 500 may further comprise a display 400 for displaying the output images IMG2. Also the input images IMG1 may be displayed. However, as the size of the input image IMG1 may be very large, it may be so that only a small portion of the input image IMG1 can be displayed at a time at full resolution. The user of the imaging device 500 may use the interface 240 e.g. for selecting an image capturing mode, exposure time, optical zoom (i.e. optical magnification), digital zoom (i.e. cropping of digital image), and/or resolution of an output image IMG2.

The imaging device 500 may be any device with an image sensor, for example a digital still image or video camera, a portable or fixed electronic device like a mobile phone, a laptop computer or a desktop computer, a video camera, a television or a screen, a microscope, a telescope, a car or a, motorbike, a plane, a helicopter, a satellite, a ship or an implant like an eye implant. The imaging device 500 may also be a module for use in any of the above mentioned apparatuses, whereby the imaging device 500 is operatively connected to the apparatus e.g. by means of a wired or wireless connection, or an optical connection, in a fixed or detachable manner.

The device 500 may also omit having an image sensor. It may be feasible to store outputs of binary pixels from another device, and merely process the binary image IMG1 in the device 500. For example, a digital camera may store the binary pixels in raw format for later processing. The raw format image IMG1 may then be processed in device 500 immediately or at a later time. The device 500 may therefore be any device that has means for processing the binary image IMG1. For example, the device 500 may be a mobile phone, a laptop computer or a desktop computer, a video camera, a television or a screen, a microscope, a telescope, a car or a motorbike, a plane, a helicopter, a satellite, a ship, or an implant like an eye implant. The device 500 may also be a module for use in any of the above mentioned apparatuses, whereby the imaging device 500 is operatively connected to the apparatus e.g. by means of a wired or wireless connection, or an optical connection, in a fixed or detachable manner. The device 500 may be implemented as a computer program product that comprises computer program code for determining the output image from the raw image. The device 500 may also be implemented as a service, wherein the various parts and the processing capabilities reside in a network. The service may be able to process raw or binary images IMG1 to form output images IMG2 to the user of the service. The processing may also be distributed among several devices.

The control unit 220 may be arranged to control the operation of the imaging device 500. The control unit 220 may be arranged to send signals to the image sensor 100 e.g. in order to set the exposure time, in order to start an exposure, and/or in order to reset the pixels of the image sensor 100.

The control unit 220 may be arranged to send signals to the imaging optics 10 e.g. for performing focusing, for optical zooming, and/or for adjusting optical aperture.

Thanks to image processing according to the present invention, the output memory MEM2 and/or the external memory EXTMEM may store a greater number of output images IMG2 than without said image processing. Alternatively or in addition, the size of the memory MEM2 and/or EXTMEM may be smaller than without said image processing. Also the data transmission rate via the data bus 242 may be lowered. These advantages may be achieved without visible loss in image resolution due to the processing in the signal processor CSU1.

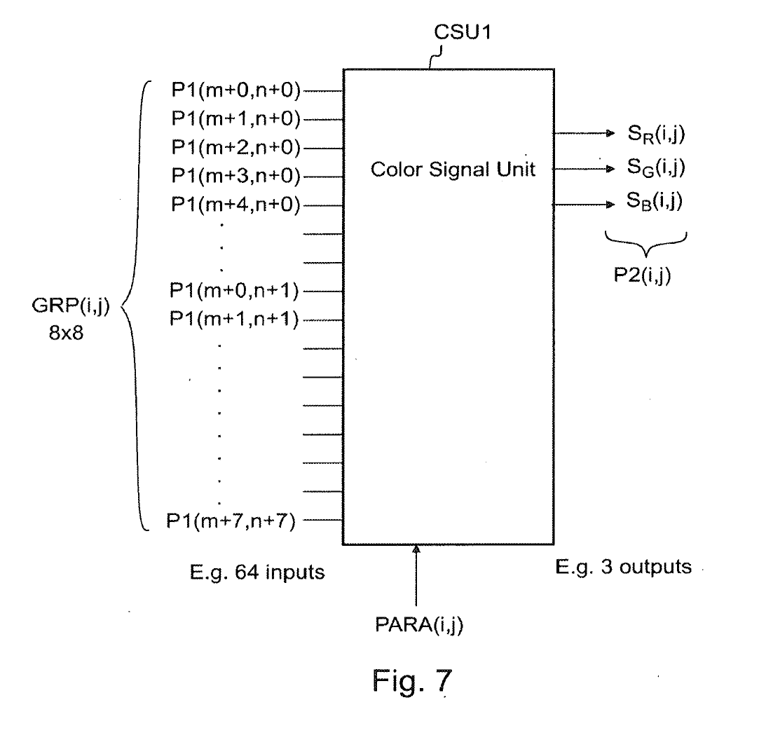

FIG. 7 shows a color signal unit CSU1 for forming output pixels from binary pixels. The color signal unit or signal processor CSU1 may have a large number of inputs, e.g. 16, 35, 47, 64, 280, 1400, 4096, 10000 or more, corresponding to pixels P1 in the input image IMG1. For example, the inputs may correspond to the binary pixels of groups GRP(i,j) and be binary values from pixels P1(m+0,n+0) to P1(m+7,n+7), the binary values indicating whether the corresponding pixel has been exposed or not (being in the white or black state, correspondingly). In FIG. 7, the indices m and n may specify the coordinates of the upper left corner of an input pixel group GRP(i,j), which is fed to the inputs of the color signal unit CSU1. For example, when processing the group GRP(1,1), in order to calculate the color values for the output pixel P2(1,1), the values (i.e. states) of the input pixels P1(1,1), P1(2,1), P1(3,1) . . . P1(6,8), P1(7,8), and P1(8,8) may be fed to 64 different inputs of the color signal unit CSU1.

The color signal unit or signal processor CSU1 may take other data as input, for example data PARA(i,j) related to processing of the group GRP(i,j) or general data related to processing of all or some groups. It may use these data PARA by combining these data to the input values P1, or the data PARA may be used to control the operational parameters of the color signal unit CSU1. The color signal unit may have e.g. 3 outputs or any other number of outputs. The color values of an output pixel P2(i,j) may be specified by determining e.g. three different output signals S_{R}(i,j) for the red color component, S_{G}(i,j) for the green color component, and S_{B}(i,j) for the blue color component. The outputs may correspond to output pixels P2(i,j), for example, the outputs may be the color values red, green and blue of the output pixel. The color signal unit CSU1 may correspond to one output pixel, or a larger number of output pixels.

The color signal unit CSU1 may also provide output signals, which correspond to a different color system than the RGB-system. For example, the output signals may specify color values for a CMYK-system (Cyan, Magenta, Yellow, Key color), or YUV-system (luma, 1st chrominance, 2nd chrominance). The output signals and the color filters may correspond to the same color system or a different color systems. Thus, the color signal unit CSU1 may also comprise a calculation module for providing conversion from a first color system to a second color system. For example, the image sensor 100 may be covered with red, green and blue filters (RGB system), but the color signal unit CSU1 may provide three output signals according to the YUV-system.

The color signal unit CSU1 may provide two, three, four, or more different color signals for each output pixel P2.

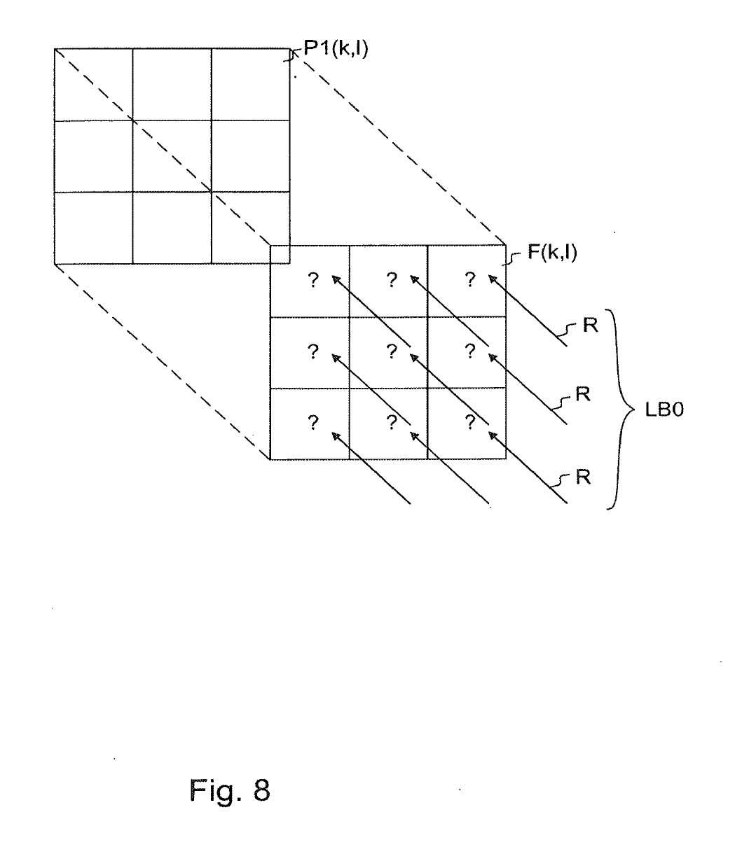

FIG. 8 shows an arrangement for determining a color filter layout overlaying a binary pixel array. The probability of changing state for the binary pixels P1(k,l)may be a function of the intensity of incoming light, as explained earlier in the context of FIGS. 3a and 3b. Further, the binary pixels P1(k,l) may have a color filter F(k,l) on top of the binary pixel, as explained in the context of FIGS. 4 and 5. Due to the irregular shape and size of the color filters and/or due to unknown alignment of the color filter array with the binary pixel array, the color of the filter F(k,l) (or colors of the filters) on top of the binary pixel P1(k,l) may not be known. The unknown color filter values have been marked with question marks in FIG. 8.

For example, after the color filter array has been manufactured on top of the binary pixel array, it may not be immediately known which Bayer matrix element overlays on top of which binary pixel (as in FIG. 4), or which color filter is on top of which binary pixel in an irregular setup (as in FIG. 5). The color filter array may also be irregular with respect to its colors, i.e. the colors of the filter elements may not be exactly of the color as intended. It might also be possible that the location and the color of the filters may also change over time, e.g. due to mechanical or physical wearing or due to exposure to light.

To determine color values for the color filters F(k,l), a light beam LB0 of known color or a known input image may be applied to the binary pixel array through the color filter array. The output of the binary pixels, i.e. the response of the binary pixels to the known input, may then be used to determine information of the color filter array. For example, pixel array may be exposed several times to different color of input light beams LB0 or different input images. The outputs of the binary pixels may be recorded and processed. For example, the binary pixels P1(k,l) may be grouped to groups GRP(i,j), as explained in the context of FIGS. 4 and 5, and the information of each group GRP(i,j) may be processed separately. This will be explained later.

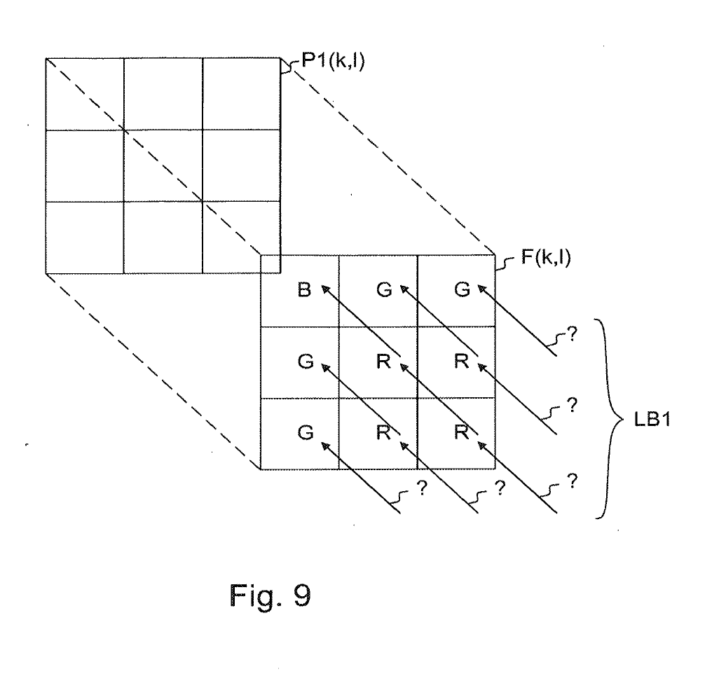

FIG. 9 shows an arrangement for determining color of incoming light with a color filter overlaying a binary pixel array. At this point, there exists some information about the color filters F(k,l), for example, the individual color filters may be knows, or the number of different color filters red, green and blue related to the groups GRP(i,j) of binary pixels may be known. It may also be that only a transformation from the binary pixel array P1(k,l) to the output pixel array P2(i,j) is known or at least partially known. This information of the color filter array F(k,l) may comprise information on the colors of the filters, information on non-functioning pixels, and/or information on pixels that do not have an associated color filter.

The information on the color filters F(k,l) may now be used to determine information of incoming light LB1. For example, the incoming light may be formed by a lens system, and may therefore form an image on the image sensor 100. When the incoming light passes through the color filters F(k,l) to the binary pixel array P1(k,l), it causes some of the binary pixels to be exposed (to be in the white state). Because the light LB1 has passed through a colour filter, the image IMG1 formed by the exposed binary pixels has information both on the intensity of light as well as the color of light LB1 hitting each binary pixel. When the image IMG1 is transformed into image IMG2 by using the information about the color filters F(k,l), for example by grouping the binary pixels to groups GRP(i,j) for forming the pixels P2(i,j) of the image IMG2, the color information may be decoded from the light LB1, and the each pixel of image IMG2 may be assigned a set of brightness values, one brightness value for each color component R, G, B.

In other words, a picture created by the camera optics onto the binary pixel array having superimposed color filters may cause the binary pixels to activate based on the color of light hitting the pixel and the color of the filter F(k,l) on top of the pixel. For example, when blue light hits a blue color filter F(k,l), the intensity of the light may not be diminished very much when it passes through the filter. Therefore, the binary pixel underneath the blue filter may have a high probability of being in the white state (being exposed). On the other hand, when blue light hits a red color filter F(k,l), the intensity of the light may be diminished to a greater degree. Therefore the binary pixel underneath the red filter may have a low probability of being in the white state (being exposed). Consequently, when a larger group of binary pixels GRP(i,j) is exposed to a certain color of light, say blue, more binary pixels having the corresponding color filter (e.g. blue) will be activated to the white state compared to those that have a color filter of another color (red and green). This exposure values (white/black) of the individual binary pixels may be used by a color signal unit CSU1 to form an output image IMG2.

Next, the operation of neural networks will be described. A neuron is the basic processing unit of the neural network. A neuron may be specified by giving a weight vector w of length n, a bias term θ and an activation function f. The neuron takes n input values x=x₁ . . . xₙ and calculates its output value for example by xw^{T}+θ, where T denotes a transpose of a vector or a matrix, or by applying the activation function to the input values and weights.

A neural network is an interconnected net of neurons. It can be considered as a directed graph, where each neuron is a node and the edges denote the connections between neurons. A feed-forward neural network is a special kind of neural network, in which neurons are organized into layers. Neurons in layer L receive their inputs from the previous layer, and their outputs are connected to the inputs of the neurons in the next layer. There may be no connections between the neurons in the same layer and the information may essentially move from one layer to the next with no feedback connections between the layers, hence the name feed-forward neural network.

There may be three types of layers: an input layer, hidden layers and an output layer. The inputs are applied at the input layer, and the outputs of the neurons in the output layer is the output of the neural network. The layers between the input layer and the output layer may be called the hidden layers. There are other types of neural networks, but in these example embodiments, for sake of simplicity, feed-forward neural networks are considered.

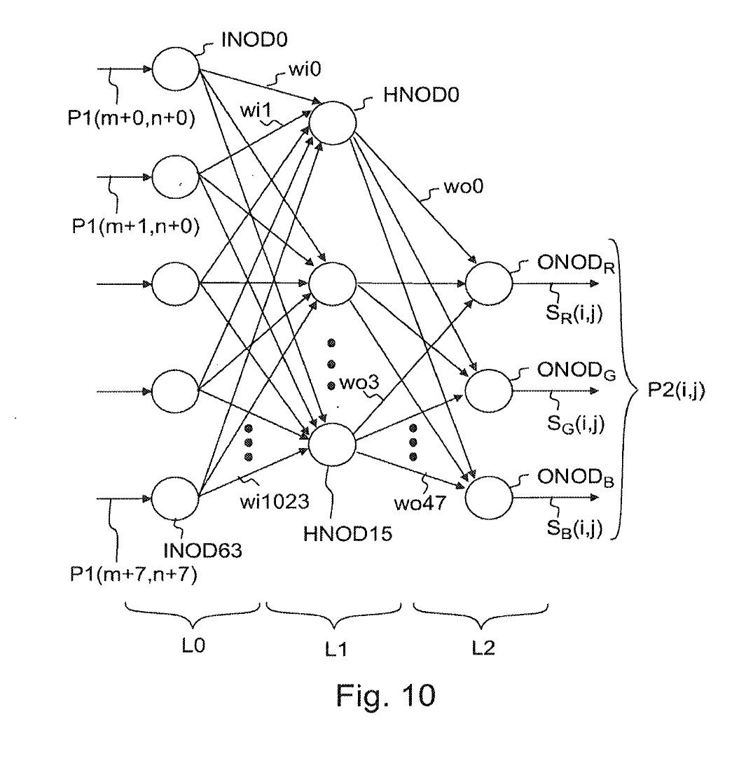

FIG. 10 shows a neural network for forming an output pixel value (e.g. three color components as three outputs) from binary input pixel values. The neural network may be formed by specialized hardware or it may be formed by computer software e.g. in the color signal unit CSU1. The neural network may have inputs formed from the values of the binary pixels P1. The neural network may have e.g. 16, 50, 64, 128, 180, 400, 1000, 90000 or 1 million inputs or more. In the example of FIG. 10, the neural network has 64 inputs P1(m+0,n+0) to P1(m+7,n+7). The 64 inputs of the neural network are connected to the nodes INOD0 through INOD63, respectively. The INOD nodes constitute a so-called input layer L0. The input layer nodes may have an activation function that defines the output of the node as a function of the input. This activation function may be linear or non-linear.

The input layer nodes are connected to the hidden layer L1 nodes HNOD0 through HNOD15, i.e. in the example, there are for example 16 hidden layer nodes. The connections between the input layer nodes and the hidden layer nodes have associated weights or coefficients wi0 through wi1023. The values from the input layer nodes INOD connected to a specific hidden layer node are multiplied with the respective weights to form the inputs to the hidden layer node. For example, the value from input layer node INOD0 is multiplied with weight wi0 and used with other inputs to form an input vector to the hidden layer node HNOD0. The hidden layer nodes may have an activation function that defines the output of the node as a function of the inputs. This activation function may be linear or non-linear.

The hidden layer nodes are connected to the output layer L2 nodes ONOD_{R}, ONOD_{G} and ONOD_{B}, i.e. in the example, there are 3 output layer nodes. The connections between the hidden layer nodes and the output layer nodes have associated weights or coefficients wo0 through wo47. The values from the hidden layer nodes HNOD connected to a specific output layer node are multiplied with the respective weights to form the inputs to the output layer node. For example, the value from hidden layer node HNOD0 is multiplied with weight wo0 and used with other inputs to form an input vector to the output layer node HNOD_{R}. The output layer nodes may have an activation function that defines the output of the node as a function of the inputs. This activation function may be linear or non-linear. The output layer nodes ONOD_{R}, ONOD_{G} and ONOD_{B} may produce outputs that correspond to the red (S_{R}(id)), green (S_{G}(i,j)) and blue (S_{B}(i,j)) values of an output pixel P2(i,j)

The neural network may be arranged so that the activation function of the input layer nodes is a linear function, the activation function of the hidden layer nodes is a non-linear function, for example a sigmoid function, and the activation function of the output layer nodes is a linear function. The activation functions of the different neurons in each layer may be the same, or they may be different.

Next it will be explained how neural networks may be used to infer the color values of incoming light, given the output of the binary sensor array. Assuming that there are n sensors in the sensor array and that m color bands are used to represent the spectrum, a neural network with n binary inputs, m outputs and one hidden layer may be created. The weights of the neural network may be initialized to random values. The activation function in the hidden layer may be a log-sigmoid function, and a linear function in the output layer. More than one hidden layer may be used. The number of neutrons in the hidden layer may depend on the complexity of color filters, and the number of neurons in the input and the output layers. After the training data is obtained, the network is trained by updating the weights and bias terms using a conjugate gradient algorithm. Training is stopped after acceptable error level is reached.

The color filters on top of each pixel may not be known individually even after training the neural network. The color filter values may be determined and taught to the neural network. Training the individual color filter values the neural network may not be needed. The neural network may be able to determine the output pixels P2 from the input pixels P1 without having specific information about the individual color filter values of the binary pixels. The forming of the output pixels P2 from the input pixels P1 may be done so that the neural network applies the weights and activation functions in the network to the input pixel data P1 and produces output pixels P2. Information on the color filters on top of individual pixels may thus be comprised in the weights or coefficients of the neural network. Determining the color filters may be possible to determine from the weights, or it may not be possible.

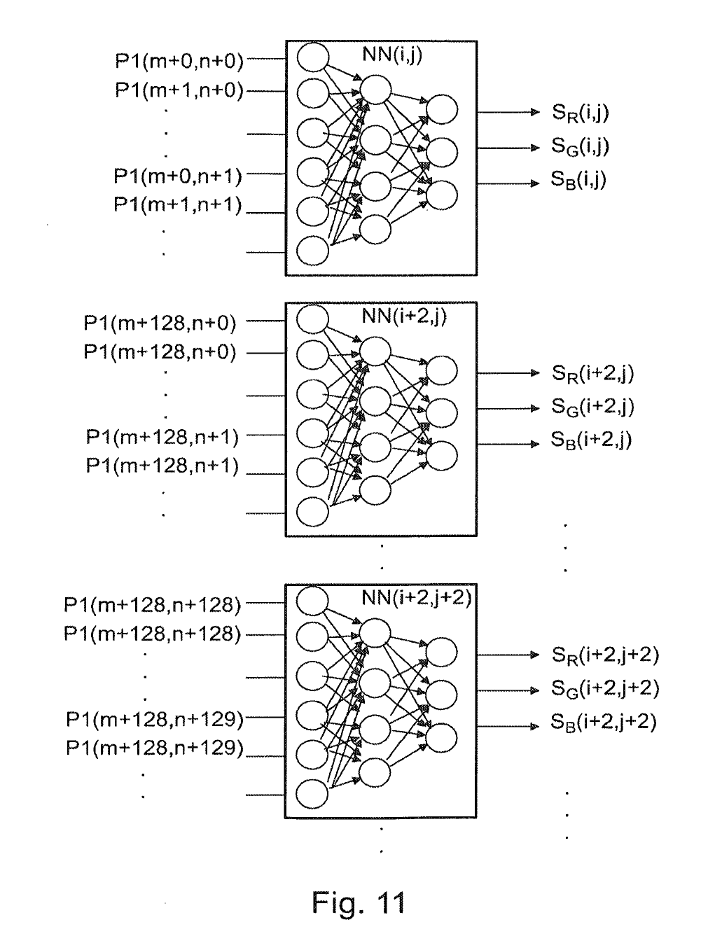

FIG. 11 shows a neural network arrangement for forming output pixel values from binary input pixel values. Different groups GRP(i,j) of the binary pixels P1 may have an associated neural network NN(i,j). These neural networks NN(i,j) may be formed by hardware or by software or by combination of hardware and software. The neural networks may be neural networks formed as explained in the context of FIG. 10. The binary pixels P1 in groups GRP(i,j) may be used as input to the neural network NN(i,j). The neural network NN(i,j) may be trained to produce correct output S_{R}(i,j), S_{G}(i,j) and S_{B}(i,j) from the input of the group GRP(i,j). This output may constitute or may be used to form the value of the output pixel P2(i,j). The different pixels P2 formed from the outputs of the neural networks NN may be used to form an output image IMG2.

The neural network NN may be formed electronically for example using analog or digital electronics, and the electronics may comprise memory either externally to the neural network or embedded to the neural network. The neural network NN may be formed by means of computer program code. The neural network may also be formed optically by means of optical components suitable for optical computing.

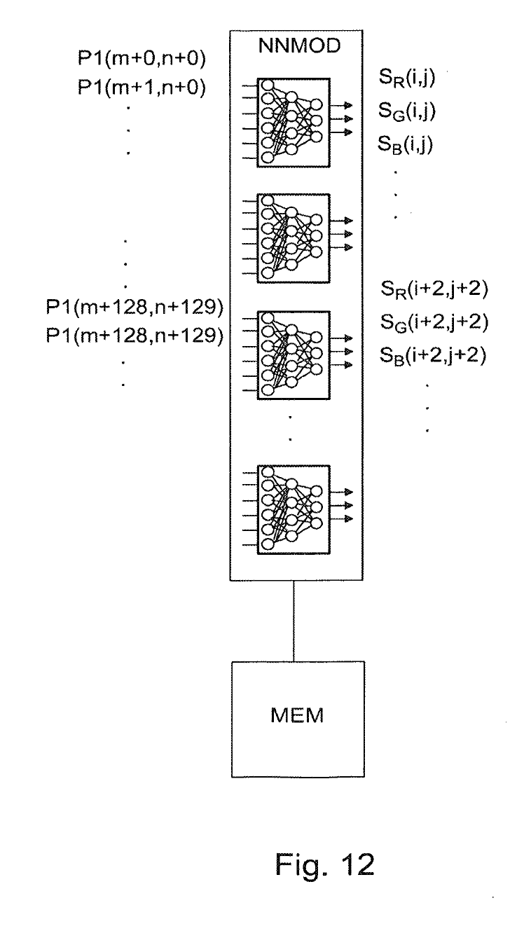

FIG. 12 shows a neural network system with a memory for forming output pixel values from binary input pixel values. The neural networks of FIG. 11 may be formed into a neural network module NNMOD. The module may comprise as many neural networks as there are output pixels P2 in the image IMG2, or the module may comprise fewer neural networks than the number of pixels P2. For example, the module NNMOD may comprise 1, 16, 64, or 1024 neural networks.

The weights of the neural networks may be completely or partly stored in the memory MEM. When a new set of input pixels is connected to the inputs of the neural network module NNMOD, a set of weights corresponding to the input pixel groups GRP may be loaded to the neural network module from memory MEM. In this manner, a smaller neural network module NNMOD may be formed than what would be required in order to process all input pixels in parallel. In other words, only a subset of input pixels is processed to output pixels at a time, with the corresponding weights for the neural networks loaded from memory MEM. The whole set of output pixels is produced by computing through the input pixels and weights.

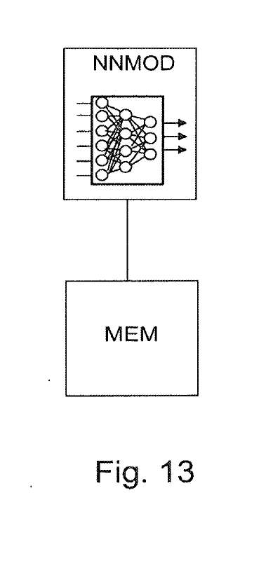

FIG. 13 shows a neural network system with a memory for forming output pixel values from binary input pixel values. In contrast with the example of FIG. 12, the neural network module NNMOD here has only one neural network with three outputs corresponding to for example the red, green and blue (or other color system component like YUV or CMYK) color values of one output pixel. Therefore, for each output pixel to be computed, a set of weights is loaded from memory MEM. The inputs from binary pixels are then applied to the input of the neural network, and the output pixel is computed.

In order to simplify loading a new set of weights and to reduce the amount of memory MEM needed, the sets of weights may be clustered. Thereby, if only a representative set of weights for each cluster is stored into the memory, fewer sets of weights may need to be stored. For example, it may not be necessary to store 10 million sets of weights, where each set corresponds to one output pixel and a group GRP of binary input pixels and their corresponding color filters F. Instead, it may be possible to store only 500 000 sets of weights, or only 10 000 sets of weights. The retrieval of weights from the memory MEM may happen in a manner that each group of input pixels has an associated index of neural network coefficients, and the coefficients are retrieved from a memory location corresponding to that index.

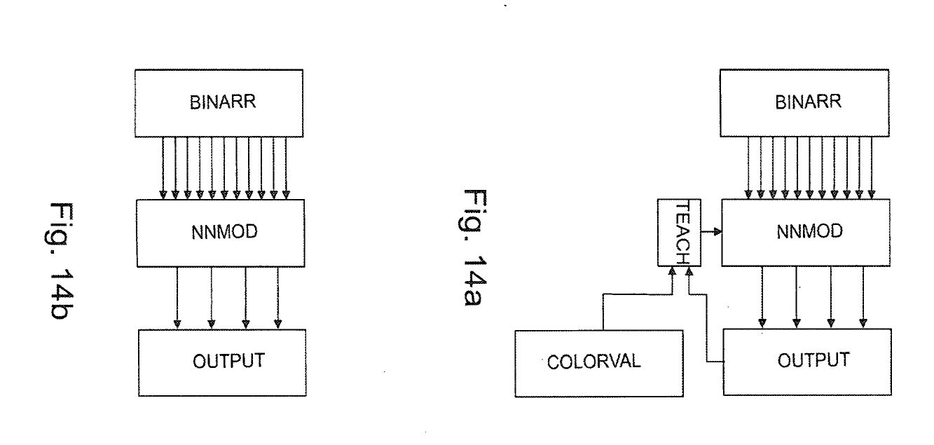

FIG. 14a shows a teaching arrangement of a neural network for forming output pixel values from binary input pixel values. Neural networks may be able to learn from examples. Instead of explicitly specifying the relations between the output and the input values, neural networks may learn relationships between input and output values from a given collection of examples. This property of neural networks may provide advantages in situations where the exact relationship between the input values is not known.

A neural network may be trained using supervised training. In supervised training, the correct output is provided for each example input pattern, and the randomly initialized weights and the bias terms of the neurons are iteratively updated to minimize the error function between the output of the neural network and the correct values. Different methods may be used for updating the weights, for example a conjugate gradient algorithm, and a back-propagation algorithm and their variants.

As explained earlier, we may have a two-dimensional array BINARR of binary valued sensors, and on the binary sensors a color filter is superposed. The spectral response of each filter is assumed to be fixed, but initially unknown. The binary array with an unknown filter is exposed repeatedly to light, and the responses of the sensor array and the color values of light are recorded. In the case of N×N binary sensor array BINARR, the training data may constitute of N×N binary matrices and the corresponding color values COLORVAL of light used to expose the sensor array.

When the binary pixel array BINARR is exposed to light, it produces an output signal from the binary pixels, which may be fed to the neural network module NNMOD as described earlier. The neural network module may then be operated to produce an output image OUTPUT. The output image and the original color values COLORVAL may be fed to the teaching unit TEACH, which may compute an adjustment to the weights of the neural network module to make the output error (the difference between COLORVAL and OUTPUT values) smaller. This adjustment may be achieved by using a back-propagation algorithm or a conjugate gradient algorithm, or any algorithm that gives adjustments to the neural network weights to make the output error smaller.

The training or teaching may happen in sections of the BINARR array, for example so that the neural network corresponding to each group GRP(i,j) is trained at one instance, and the training process goes through all groups. For each neural network, training may continue as long as a certain number of training sets has been taught, or until the output error falls below a given threshold. When the teaching has finished, the sets of weights of the neural networks may be stored into a memory. The sets of weights of the neural networks may also be clustered, as explained earlier.

FIG. 14b shows an arrangement for applying a neural network for forming output pixel values from binary input pixel values. When the binary pixel array BINARR is exposed to light, it produces an output signal from the binary pixels, which may be fed to the neural network module NNMOD as described earlier. The neural network module may then be operated to produce an output image OUTPUT. At this stage, the neural network module comprises or has access to the appropriate sets of weights corresponding to the input pixel values from BINARR. The neural network may therefore produce a true output picture that corresponds to the image projected onto the array BINARR by the optics.

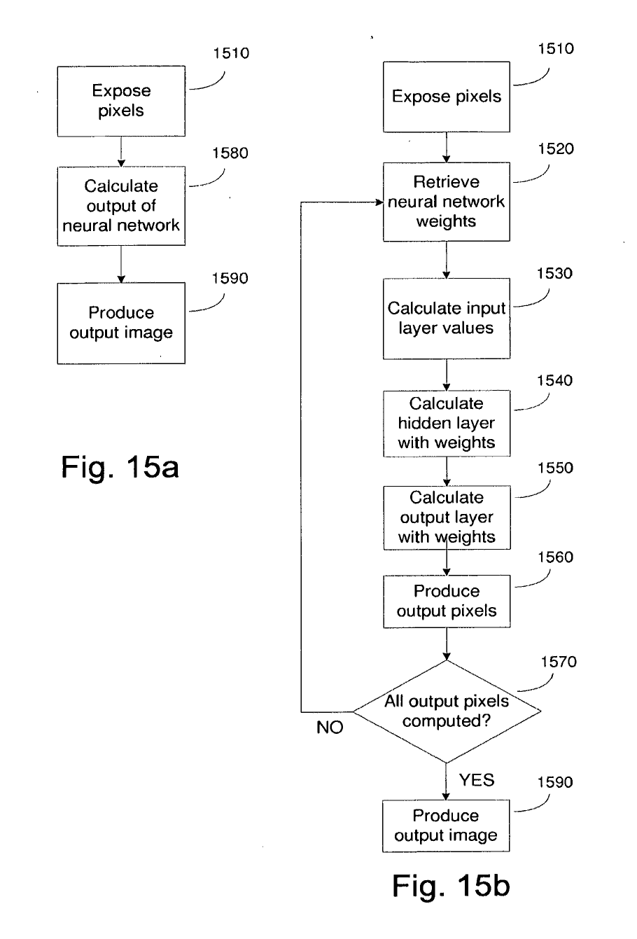

FIG. 15a shows a method for producing an output image from binary input pixels using a neural network. In 1510, the binary pixels having associated color filters are exposed to a picture formed by the optics, and the binary pixels produce a set of input pixel values. In 1580, the input pixel values P1 of image IMG1 are applied to a neural network to compute the output pixel values P2. The output pixel values are then used in 1590 to compose the output image IMG2, for example by arranging them into the image in rectangular shape. It needs to be appreciated, as explained earlier, that the values of binary pixels formed by the optics and image sensors may have been captured earlier, and in this method they are merely input to the neural network. The phase 1510 may thus be omitted. It also needs to be appreciated that it may be sufficient to produce output pixels from the neural network, and forming the output image IMG2 may not be needed. Phase 1590 may thus be omitted.

FIG. 15b shows another method for producing an output image from binary input pixels using a neural network. In 1510, the binary pixels having associated color filters are exposed to a picture formed by the optics, and the binary pixels produce a set of input pixel values. In 1520, a set weights corresponding to a set of binary pixels is retrieved from memory to a neural network. In 1530, the values for the input layer of the neural network are computed from the input pixel values. Alternatively, the input pixel values may be used as such as input to the neural network. In 1540, the outputs from the input layer neurons are used to calculate the values of the hidden layer by applying weights to the output values of the input layer neurons. In 1550, the outputs from the hidden layer neurons are used to calculate the values of the output layer by applying weights to the output values of the hidden layer. In 1560, the output layer produces output values to form output pixels. If all output pixels have been computed in 1570, the output pixel values are used in 1590 to compose the output image IMG2, for example by arranging them into the image in rectangular shape. Otherwise, the method continues with another set of input pixels from 1520. It needs to be appreciated, as explained earlier, that the values of binary pixels formed by the optics and image sensors may have been captured earlier, and in this method they are merely input to the neural network. The phase 1510 may thus be omitted. It also needs to be appreciated that it may be sufficient to produce output pixels from the neural network, and forming the output image IMG2 may not be needed. Phase 1590 may thus be omitted.

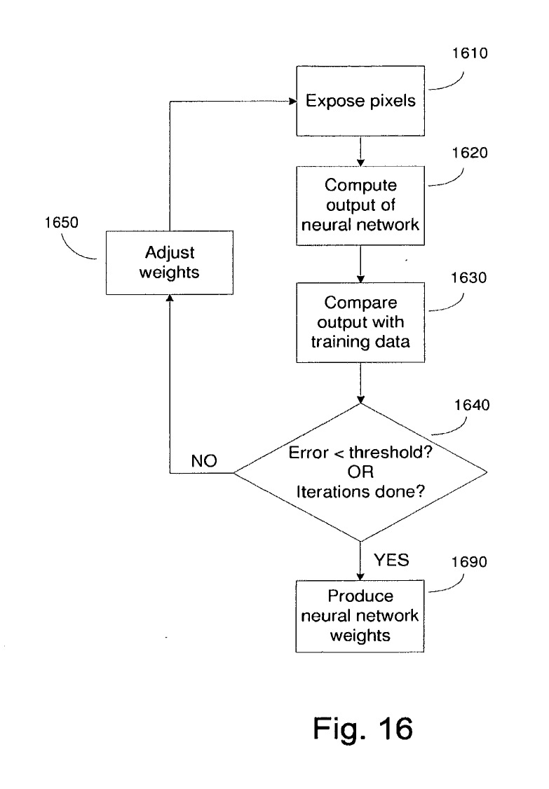

FIG. 16 shows a method for teaching a neural network for producing output image from binary input pixels. In 1610, the binary pixels having associated color filters are exposed to a known picture or input light, and the binary pixels produce a set of input pixel values. In 1620, the input pixel values P1 of image IMG1 may be applied to a neural network to compute the output pixel values P2. In 1630, the output pixel values P2 may be compared to the known input to determine the error between the known data and the output of the neural network. If the error is large enough in 1640, the weights of the neural network may be adjusted in 1650 to decrease the error between the input data and the output data before exposing the input pixels again in 1610. When in 1640 the error is smaller than a given threshold or a given number of training cycles has been carried out, the method may be stopped and the neural network weights be produced in 1690 for example to be stored in a memory.

The exposure of the binary pixels may also be carried out separately, and the values of the binary pixels associated with each exposure may be recorded. Then, instead of exposing the binary pixels, the training method may be applied to the neural network separately. In fact, the training may happen in a completely separate device having a similar setup of neural networks. This may be done, for example, to be able to compute the sets of weights faster, for example in a factory assembly line for cameras or other electronic devices.

Using neural networks may have advantages, for example because the placement or type of color filters may not need to be known in advance. The design of neural networks can be varied in terms of number of hidden layers and number of neurons used. More neurons may be required for more complicated filter setups. By having a sufficient amount of training data, over-fitting may be avoided. The number of training samples may be several magnitudes greater than the number of weights in the neural network to avoid over-fitting. Pruning algorithms and available prior information may also be used to help in the training phase.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is clear that the present invention is not limited solely to the above-presented embodiments, but it can be modified within the scope of the appended claims.

1. A method for forming pixel values, comprising:
receiving binary pixel values in an image processing system, the binary pixel values having been formed with binary pixels with color filters, and
applying a neural network to said binary pixel values to produce output pixel values.

2. A method according to claim 1, comprising:
exposing said binary pixels to light through color filters superimposed on said binary pixels, said light having passed through an optical arrangement, and
forming said binary pixel values from the output of said binary pixels.

3. A method according to claim 1, comprising:
setting parameters or weights in said neural network corresponding to said binary pixels, and
forming at least one output pixel value from the output of said neural network.

4. A method according to claim 1, comprising:
calculating a value of a neuron in said neural network by applying weights to input signals to said neuron and by calculating the output of said neuron using an activation function, and
calculating values of neurons in layers in said neural network, wherein the layers comprise at least one of the group of an input layer, a hidden layer and an output layer.

5. An apparatus comprising at least one processor, memory including computer program code, the memory and the computer program code configured to, with the at least one processor, cause the apparatus to perform at least the following:
receive binary pixel values in an image processing system, the binary pixel values having been formed with binary pixels with color filters, and
apply a neural network to said binary pixel values to produce output pixel values.

6. An apparatus according to claim 5, further comprising computer program code configured to, with the processor, cause the apparatus to perform at least the following:
expose said binary pixels to light through color filters superimposed on said binary pixels, said light having passed through an optical arrangement, and
form said binary pixel values from the output of said binary pixels.

7. An apparatus according to claim 5, comprising computer program code configured to, with the processor, cause the apparatus to perform at least the following:
set parameters or weights in said neural network corresponding to said binary pixels, and
form at least one output pixel value from the output of said neural network.

8. An apparatus according to claim 5, comprising computer program code configured to, with the processor, cause the apparatus to perform at least the following:
calculate a value of a neuron in said neural network by applying weights to input signals to said neuron and by calculating the output of said neuron using an activation function, and
calculate values of neurons in layers in said neural network, wherein the layers comprise at least one of the group of an input layer, a hidden layer and an output layer.

9. An apparatus according to claim 5, comprising:
a color signal unit comprising at least one said neural network, and
a memory for storing parameters and/or weights of at least one said neural network.

10. An apparatus according to claim 5, comprising:
an optical arrangement for forming an image,
an array of binary pixels for detecting said image, and
groups of said binary pixels.

11. An apparatus according to claim 5, comprising:
at least one color filter superimposed on an array of binary pixels, said color filter being superimposed on said array of binary pixels in a manner that is at least one of the group of non-aligned, irregular, random, and unknown superimposition.

12. A method for adapting an image processing system, comprising:
receiving binary pixel values in an image processing system, the binary pixel values having been formed with binary pixels with color filters,
applying a neural network to said binary pixel values to produce output pixel values,
comparing information on said received binary pixel values to information on said output pixel values, and
based on said comparing, adapting parameters of said neural network.

13. method according to claim 12, comprising:
exposing said binary pixels to light through color filters superimposed on said binary pixels, said light having passed through an optical arrangement, and
forming said binary pixel values from the output of said binary pixels.

14. A method according to claim 12, comprising:
calculating a value of a neuron in said neural network by applying weights to input signals to said neuron and by calculating the output of said neuron using an activation function, and
calculating values of neurons in layers in said neural network, wherein the layers comprise at least one of the group of an input layer, a hidden layer and an output layer.

15. An apparatus comprising at least one processor, memory including computer program code, the memory and the computer program code configured to, with the at least one processor, cause the apparatus to perform at least the following:
receive binary pixel values in an image processing system, the binary pixel values having been formed with binary pixels with color filters,
apply a neural network to said binary pixel values to produce output pixel values,
compare information on said received binary pixel values to information on said output pixel values, and
based on said comparing, adapt parameters of said neural network.

16. An apparatus according to claim 15, comprising computer program code configured to, with the processor, cause the apparatus to perform at least the following:
expose said binary pixels to light through color filters superimposed on said binary pixels, said light having passed through an optical arrangement, and
form said binary pixel values from the output of said binary pixels.

17. An apparatus according to claim 15, comprising computer program code configured to, with the processor, cause the apparatus to perform at least the following:
calculate a value of a neuron in said neural network by applying weights to input signals to said neuron and by calculating the output of said neuron using an activation function, and
calculate values of neurons in layers in said neural network, wherein the layers comprise at least one of the group of an input layer, a hidden layer and an output layer.

18. A computer program product stored on a computer readable medium and executable in a data processing device, wherein the computer program product comprises:
a computer program code section for receiving binary pixel values, the binary pixel values having been formed with binary pixels with color filters,
a computer program code section for applying a neural network to said binary pixel values to produce output pixel values, and
a computer program code section for using said output pixel values to form an output image.

19. A computer program product according to claim 18, wherein the computer program product comprises:
a computer program code section for receiving parameters or weights for said neural network,
a computer program code section for setting said parameters or weights in a neural network, and
a computer program code section for forming output pixel values from the output of said neural network.

20. (canceled)
